(19) United States
(12) Patent Application Publication
(10) Pub. No.: US 2016/0047513 A1
(43) Pub. Date: Feb. 18, 2016

(54) LASER OPTICAL SYSTEM AND LAMP FOR VEHICLE HAVING THE SAME

(71) Applicant: Hyundai Mobis Co., Ltd., Seoul (KR)

(72) Inventor: Nam Hyeok KWAK, Yongin-si (KR)

(21) Appl. No.: 14/810,757

(22) Filed: Jul. 28, 2015

(30) Foreign Application Priority Data
Aug. 12, 2014 (KR) 10-2014-0104632

(51) Int. Cl. F21K 99/00; F21S 8/10

(52) U.S. Cl. CPC F21K 9/56; F21S 48/328; F21S 48/00; F21Y 2101/025

(57) ABSTRACT

A laser optical system including a laser diode, a phosphor configured to change a color of a light emitted from the laser diode, a lens that is positioned between the laser diode and the phosphor, the lens configured to concentrate the light emitted from the laser diode toward the phosphor, and a drive unit that is connected to the phosphor.

### CROSS-REFERENCE TO RELATED APPLICATION

This application claims priority from and the benefit of Korean Patent Application No. 10-2014-0104632, filed on Aug. 12, 2014, which is hereby incorporated by reference for all purposes as if fully set forth herein.

### BACKGROUND

1. Field

Exemplary embodiments relate to a laser optical system. More particularly, exemplary embodiments relate to a laser optical system having an operable phosphor.

2. Discussion of the Background

Vehicles generally have headlights or lamps that allow a driver to easily see objects at the periphery of the vehicle at night. Vehicles also may have turn signals that inform other drivers and pedestrians of a particular driving state (i.e., the vehicle is turning).

A light source used for the vehicle lamps range from incandescent bulbs in older vehicles to light emitting diodes (LEDs) or laser diodes in more recent vehicles.

Some vehicles have LED optical system lamps that include white light by applying a phosphor directly onto a blue chip.

Using white light by applying a phosphor onto a blue chip for laser optical systems, as opposed to LED optical systems, have higher brightness that may damage the phosphor. Therefore, laser optical systems typically separate phosphor from the laser diode.

Vehicle lamps that use laser optical systems have performance limits that are linked to the use of phosphor. The phosphor with high heat resistance is expensive and inexpensive phosphor cannot sufficiently perform in laser optical system lamps for vehicles.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a laser optical system and a lamp for a vehicle using the same that may ensure high brightness performance of a laser module by vibrating a phosphor using a drive unit in order to satisfy heat resistance performance of the phosphor.

Additional aspects will be set forth in the detailed description which follows, and, in part, will be apparent from the disclosure, or may be learned by practice of the inventive concept.

An exemplary embodiment discloses a laser optical system including a laser diode, a phosphor configured to change a color of a light emitted from the laser diode, a lens that is positioned between the laser diode and the phosphor, the lens configured to concentrate the light emitted from the laser diode toward the phosphor, and a drive unit that is connected to the phosphor.

An exemplary embodiment also discloses a vehicle lamp including a laser diode, a phosphor configured to change a color of a light emitted from the laser diode, a lens that is positioned between the laser diode and the phosphor, the lens configured to concentrate the light emitted from the laser diode toward the phosphor, and a drive unit that is connected to the phosphor.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a view illustrating a structure of a laser optical system according to an exemplary embodiment.

FIG. 2 is a view illustrating an exemplary embodiment of a drive unit illustrated in FIG. 1.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the spacing, size, and relative sizes of elements, regions, etc., may be exaggerated for clarity and descriptive purposes. Also, like reference numerals denote like elements.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

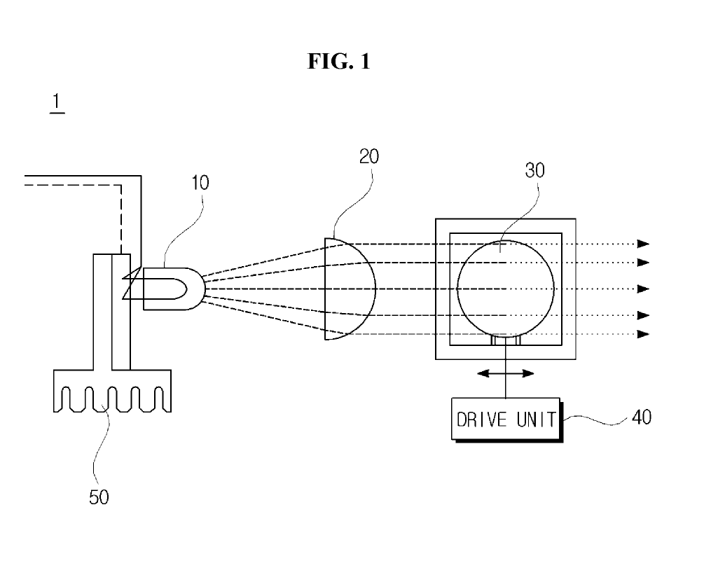

FIG. 1 is a view illustrating a structure of a laser optical system according to an exemplary embodiment.

Referring to FIG. 1, the laser optical system may include a laser diode 10, a lens 20, a phosphor 30, and a drive unit 40.

The laser diode 10 is advantageous because it is brighter than an LED. The laser diode 10 also emits light straighter than the LED, and thus may emit light at a brightness of five or more times higher than a comparable LED. In one exemplary embodiment, a blue laser diode may be used as the laser diode 10.

The lens 20 serves to allow light emitted from the laser diode 10 to travel straight forward. In an exemplary embodiment, the lens 20 concentrates light emitted from the laser diode 10 and directs the light to the phosphor 30. The lens 20 may have a light incident surface that is formed in a substantially flat shape in order to concentrate light, and a light emitting surface which has a substantially convex cross-sectional shape. In addition, the lens 20 may be made of various suitable materials such as compressed plastic or glass.

The light concentrated by the lens 20 travels to the phosphor 30 and then phosphor 30 converts the light into white light. The higher the level of light concentrated by the lens 20, the higher the brightness that may be implemented by the phosphor 30. A laser module used for a high beam may allow light to propagate two or more times greater distance than light emitted from the LED because the brightness of the light from the laser module is five or more times higher than brightness of the LED. However, a degradation reaction occurs in the phosphor 30 as the light emitted from the laser diode 10 is concentrated there. In order to solve the degradation reaction problem, the phosphor 30 is connected with the drive unit 40. This configuration will be described below.

The drive unit 40 may be connected with the phosphor 30. As described above, a problem regarding heat resistance occurs in the phosphor 30 when laser light is concentrated. The problem is caused by the phosphor 30 having low thermal conductivity. Thus, heat cannot be easily disperse from the phosphor to the periphery resulting in an increased localization of the heat at the phosphor. The laser module for a high beam concentrates the light from the laser to produce laser with a diameter of 100 μm or less and emits the concentrated laser light to the phosphor 30. In order to prevent the phosphor 30 from being damaged due to the light concentration, the drive unit 40 vibrates the phosphor 30 so that the concentrated light from the laser is prevented from being concentrated at only one portion of the phosphor 30, thereby preventing damage to the phosphor 30. Because a size of laser concentration is very small, it is possible to greatly raise a heat resistance limit of the phosphor 30 using only a small amount of displacement.

The drive unit 40 may be mechanically operated or may be autonomously operated depending on movement of the vehicle.

In an exemplary embodiment, the drive unit 40 is mechanically operated and configured as a motor. In a case in which the drive unit 40 is configured as a motor, a separate support unit (not illustrated) for supporting the phosphor 30 may be added.

A heat radiating plate 50 may be connected at one side of the laser diode 10. A large amount of heat is generated when light is emitted from the laser diode 10. As a result, it is difficult to use the laser diode 10 because the large amount of generated heat (i.e., high temperature). In a case in which heat is not properly radiated, efficiency and durability of the lamp deteriorate. In order to prevent deterioration, the heat radiating plate 50 may be installed. In an exemplary embodiment, various types of heat radiating plates such as a heat sink, a slug, or water cooling type heat radiating plate may be used as the heat radiating plate (not illustrated).

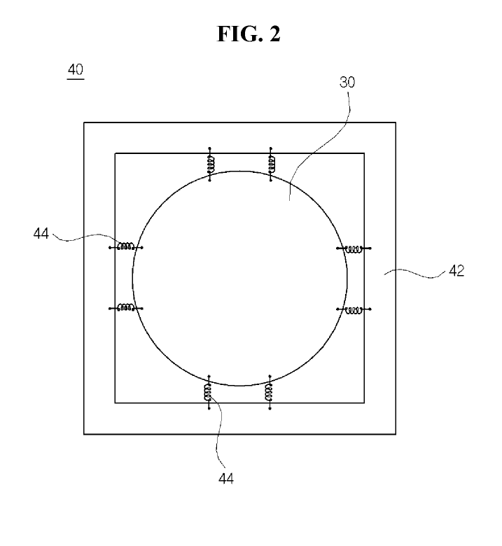

FIG. 2 is a view illustrating a structure of the drive unit 40 that is a constituent element of the laser optical system according to the exemplary embodiment of the present invention.

Referring to FIG. 2, the drive unit 40 may be autonomously operated depending on movement of the vehicle and may include a frame 42 and elastic bodies 44.

The frame 42 may have a space that accommodates the elastic bodies 44 and may be fixed to one region inside a lamp housing (not illustrated). In an exemplary embodiment, the frame 42 may be formed in a quadrangular shape and may be variously modified in accordance with a shape of the phosphor 30.

The elastic body 44 may connect the frame 42 and the phosphor 30. In an exemplary embodiment, a first end of the elastic body 44 is connected to the frame 42, and the second end of the elastic body 44 is connected with the phosphor 30. Multiple elastic bodies 44 may be connected to upper, lower, left, and right portions of the phosphor 30, and then fixed to the frame 42.

The phosphor 30 connected with the elastic bodies 44 may be automatically shaken by the movement of the vehicle, thereby preventing laser from being concentrated at one portion of the phosphor 30.

A size of the phosphor 30 may be determined through an experiment so as to prevent light emitted from the laser diode 10 from deviating from a range of the phosphor 30 due to the movement of the vehicle. In an exemplary embodiment, the elastic body 44 may be configured as a spring, and may be variously modified to support movement of the phosphor 30.

As described above, the laser optical system according to the exemplary embodiments may allow light to propagate two times greater distance than light emitted from the LED lamp, thereby improving convenience for a driver and driving stability while the vehicle travels at a high speed.

It is also possible to solve a safety problem that may occur as a phosphor is damaged in a laser headlamp.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A laser optical system, comprising:
a laser diode;
a phosphor configured to change a color of a light emitted from the laser diode;
a lens positioned between the laser diode and the phosphor, the lens configured to concentrate the light emitted from the laser diode toward the phosphor; and
a drive unit that is connected to the phosphor.

2. The laser optical system of claim 1, wherein the drive unit is configured to vibrate the phosphor.

3. The laser optical system of claim 2, wherein the drive unit is configured as a motor.

4. The laser optical system of claim 2, wherein the drive unit is configured to operate autonomously in a vehicle by a movement of the vehicle.

5. The laser optical system of claim 1, wherein the phosphor is formed to be greater in size than an area of light that passes through the lens.

6. The laser optical system of claim 1, wherein the drive unit comprises a frame that accommodates the phosphor and a first elastic body that connects the frame and the phosphor.

7. The laser optical system of claim 6, further comprising a second elastic body that connects the frame of the drive unit to the phosphor.

8. The laser optical system of claim 6, wherein the first elastic body is configured as a spring.

9. The laser optical system of claim 1, further comprising:
a heat radiating plate connected with the laser diode.

10. A vehicle lamp, comprising:
a laser diode;
a phosphor configured to change a color of a light emitted from the laser diode;
a lens positioned between the laser diode and the phosphor, the lens configured to concentrate the light emitted from the laser diode toward the phosphor; and
a drive unit that is connected to the phosphor.

11. The vehicle lamp of claim 10, wherein the drive unit is configured to vibrate the phosphor.

12. The vehicle lamp of claim 11, wherein the drive unit is configured as a motor.

13. The vehicle lamp of claim 11, wherein the drive unit is configured to operate autonomously in a vehicle by a movement of the vehicle.
